(19) United States
(12) Patent Application Publication
(10) Pub. No.: US 2024/0204321 A1
(43) Pub. Date: Jun. 20, 2024

(54) VEHICLE BATTERY HUMIDITY CONTROL DEVICE

(71) Applicant: Ford Global Technologies, LLC, Dearborn, MI (US)

(72) Inventors: Fei Gao, Hefei (CN); Larry Wang, Nanjing (CN); Tao Shen, Nanjing (CN); Peng Fei He, Nanjing (CN); Xiuhua Zhang, Nanjing (CN)

(21) Appl. No.: 18/528,392

(22) Filed: Dec. 4, 2023

(30) Foreign Application Priority Data
Dec. 14, 2022 (CN) 2022116107268

(51) Int. Cl. H01M 50/24; B60R 16/033; H01M 50/249; H01M 50/30

(52) U.S. Cl. CPC H01M 50/24; B60R 16/033; H01M 50/249; H01M 50/394; B60L 50/60; H01M 2220/20

(57) ABSTRACT

The present disclosure provides a vehicle battery humidity control device, a corresponding vehicle battery pack and a humidity control device. The disclosed vehicle battery humidity control device comprises: a shell installed on a vehicle battery pack and formed with a receiving cavity, the receiving cavity and an internal space of the battery pack being communicated fluidly through a ventilation opening on the shell; and a humidity control core arranged in the receiving cavity and including a humidity control structure and a waterproof and breathable film located between the humidity control structure and the ventilation opening. The humidity control device proposed by the present disclosure has a more simplified overall structure, lower manufacturing and installation costs, long service life, and more convenient maintenance, achieving humidity control inside the vehicle battery pack, thereby improving user satisfaction.

### CROSS-REFERENCE TO RELATED APPLICATIONS

This disclosure claims priority to Chinese Patent Disclosure No. 2022116107268, which was filed on 14 Dec. 2022 and is incorporated herein by reference in its entirety.

### TECHNICAL FIELD

The present disclosure generally relates to the field of vehicle batteries, and more specifically, to a vehicle battery humidity control device, corresponding vehicle battery pack and humidity control device.

### BACKGROUND

In modern motor vehicles, an increase in the demand for driving distance and the number of various electrical devices inside the vehicle will lead to an increase in the demand for vehicle electricity. Battery packs used to provide power to the vehicle can occupy a larger space and have a more complex internal structure. In working condition, a large number of battery cells in the vehicle battery pack may release gas. In order to achieve pressure balance inside and outside the battery pack, currently, several vent valves are generally installed on a housing of the battery pack. The use of the vent valves not only balances the pressure inside and outside the battery pack, but also generates internal and external gas exchange. In cases of high external humidity, such as cloudy and rainy days, humid gases may condense into water vapor inside the battery pack, resulting in corresponding dehumidification needs.

United States Patent Application No. 20130252043A1 discusses a method for reducing moisture in a battery enclosure, which can inhibit battery degradation. This disclosure mentions that in one example, the method includes controlling the moisture in the battery enclosure by a desiccant material; and in another example, the method includes controlling the moisture in the battery enclosure by periodically passing electrical current through a Peltier device.

### SUMMARY

The present disclosure summarizes aspects of the embodiments and should not be used to limit the claims. Other implementations are contemplated in accordance with the techniques described herein, as will be apparent to those skilled in the art upon examination of the following drawings and detailed description, and such implementations are intended to be within the scope of this application.

According to an aspect of the present disclosure, a vehicle battery humidity control device is provided, comprising: a shell installed on a vehicle battery pack and formed with a receiving cavity, the receiving cavity being communicated to an internal space of the battery pack through a ventilation opening on the shell; and a humidity control core arranged in the receiving cavity, including: a humidity control structure; and a waterproof and breathable film located between the humidity control structure and the ventilation opening.

According to an embodiment of the present disclosure, wherein the humidity control structure comprises a first material layer and a second material layer at least partially embedded in the first material layer.

According to an embodiment of the present disclosure, wherein the first material layer comprises a mesh material layer.

According to an embodiment of the present disclosure, wherein the mesh material layer has a pore size smaller than a particle size of the material contained in the second material layer.

According to an embodiment of the present disclosure, wherein the first material layer comprises fiber cloth, and the second material layer comprises microporous hygroscopic materials.

According to an embodiment of the present disclosure, wherein the fiber cloth has warp and weft lines at an angle between 20 and 80 degrees.

According to an embodiment of the present disclosure, wherein the waterproof and breathable film encloses the humidity control structure in a closed manner.

According to an embodiment of the present disclosure, the vehicle battery humidity control device further comprises a humidity sensor configured to detect humidity inside the humidity control structure, and the humidity sensor is configured to emit an alarm signal in response to detecting that the humidity inside the humidity control structure exceeds a threshold for a first preset time, and/or to emit an alarm signal in response to detecting that a humidity change value inside the humidity control structure is less than a threshold for a second preset time.

According to an embodiment of the present disclosure, wherein the shell comprises a lower shell installed on the vehicle battery pack and an upper shell connected to the lower shell, and the upper shell and the lower shell is enclosed to form the receiving cavity.

According to an embodiment of the present disclosure, wherein the shell further includes a partition support plate that covers the ventilation opening on the lower shell and includes several air holes, and the humidity control core is arranged on the partition support plate and covers the several air holes.

According to an embodiment of the present disclosure, wherein the shell further includes a compression cover clamped onto the lower shell to compress the humidity control core to the partition support plate.

According to an embodiment of the present disclosure, wherein the compression cover is provided with an elastic pad on the side facing the humidity control core.

According to another aspect of the present disclosure, a vehicle battery pack is provided, comprising: a vehicle battery pack housing; a shell installed on the vehicle battery pack housing and formed with a receiving cavity, the receiving cavity being communicated to an internal space of the battery pack shell through a ventilation opening on the shell; and a humidity control core arranged in the receiving cavity, including: a humidity control structure comprising a first material layer and a second material layer at least partially embedded in the first material layer; and a waterproof and breathable film enclosing the humidity control structure in a closed manner.

According to an embodiment of the present disclosure, wherein the first material layer comprises a mesh material layer.

According to an embodiment of the present disclosure, wherein the mesh material layer has a pore size smaller than a particle size of the material contained in the second material layer.

According to an embodiment of the present disclosure, wherein the first material layer comprises fiber cloth, the second material layer comprises microporous hygroscopic materials, and the fiber cloth has warp and weft lines at an angle between 20 and 80 degrees.

According to an embodiment of the present disclosure, the vehicle battery pack further comprises a humidity sensor configured to detect humidity inside the humidity control structure, and the humidity sensor is configured to emit an alarm signal in response to detecting that the humidity inside the humidity control structure exceeds a threshold for a first preset time, and/or to emit an alarm signal in response to detecting that a humidity change value inside the humidity control structure is less than a threshold for a second preset time.

According to an embodiment of the present disclosure, wherein the shell comprises a lower shell installed on the vehicle battery pack housing, an upper shell connected to the lower shell, a partition support plate, and a compression cover, the upper shell and the lower shell are enclosed to form the receiving cavity, the partition support plate covers the ventilation opening on the lower shell and includes several air holes, the humidity control core is arranged on the partition support plate and covers the several air holes, and the compression cover is clamped onto the lower shell to compress the humidity control core to the partition support plate.

According to yet another aspect of the present disclosure, a humidity control device is provided, comprising: a shell formed with a receiving cavity, the receiving cavity being communicated to a ventilation opening on the shell; and a humidity control core arranged in the receiving cavity, including: a humidity control structure; and a waterproof and breathable film located between the humidity control structure and the ventilation opening.

According to an embodiment of the present disclosure, wherein the humidity control structure comprises a first material layer and a second material layer at least partially embedded in the first material layer.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

For a better understanding of the present disclosure, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further in the figures, like reference numbers refer to like parts throughout the different figures.

FIG. 1 shows a schematic diagram of a vehicle including a vehicle battery humidity control device according to one or more embodiments of the present disclosure;

FIG. 2 shows a perspective view of a vehicle battery pack according to one or more embodiments of the present disclosure;

FIG. 3 shows a side view of a vehicle battery humidity control device according to one or more embodiments of the present disclosure;

FIG. 4 shows a top view of a vehicle battery humidity control device according to one or more embodiments of the present disclosure;

FIG. 5 shows a radial cross-sectional view of a vehicle battery humidity control device according to one or more embodiments of the present disclosure;

FIG. 6 shows a perspective exploded view of a vehicle battery humidity control device according to one or more embodiments of the present disclosure;

FIG. 7 shows a cross-sectional view of a humidity control core of a vehicle battery humidity control device according to one or more embodiments of the present disclosure;

FIG. 8 shows a top view of a lower shell of a vehicle battery humidity control device according to one or more embodiments of the present disclosure;

FIG. 9 shows a top view of a lower shell and a partition support plate on it of a vehicle battery humidity control device according to one or more embodiments of the present disclosure;

FIG. 10 shows a schematic diagram of the absorption and release of moisture by humidity control materials in a vehicle battery humidity control device according to one or more embodiments of the present disclosure;

FIG. 11 shows a schematic diagram of a first material layer and a second material layer in a humidity control structure of a vehicle battery humidity control device according to one or more embodiments of the present disclosure; and

FIG. 12 shows a schematic diagram of a humidity control device according to one or more embodiments of the present disclosure, with a humidity control core located internally shown in dashed lines.

### DETAILED DESCRIPTION

Embodiments of the present disclosure are described below. However, it is to be understood that the disclosed embodiments are merely examples and other embodiments may take various and alternative forms. The figures are not necessarily to scale. Some features may be exaggerated or minimized to show details of particular components. Therefore, specific structural and functional details disclosed herein are not to be interpreted as limiting, but merely as a representative basis for teaching one skilled in the art to variously employ the present disclosure. As will be understood by those of ordinary skill in the art, various features shown and described with reference to any one figure may be combined with features shown in one or more other figures to produce embodiments not expressly shown or described. The combinations of features shown herein provide representative embodiments for typical disclosures. However, various combinations and modifications of the features consistent with the teachings of the present disclosure may be desired for certain particular applications or implementations.

In this document, when an element or part is referred to as being “on . . . ”, “bonded to”, “connected to”, or “coupled to” another element or part, the element or part can be directly on another element or part, can be bonded, connected or coupled to another element or part, or there may be intervening elements or parts. In contrast, when an element is referred to as being “directly on . . . ”, “directly bonded to”, “directly connected to”, or “directly coupled to” another element or part, the intervening elements or parts may not be present. Other words used to describe the relationship between elements should be interpreted in a like fashion.

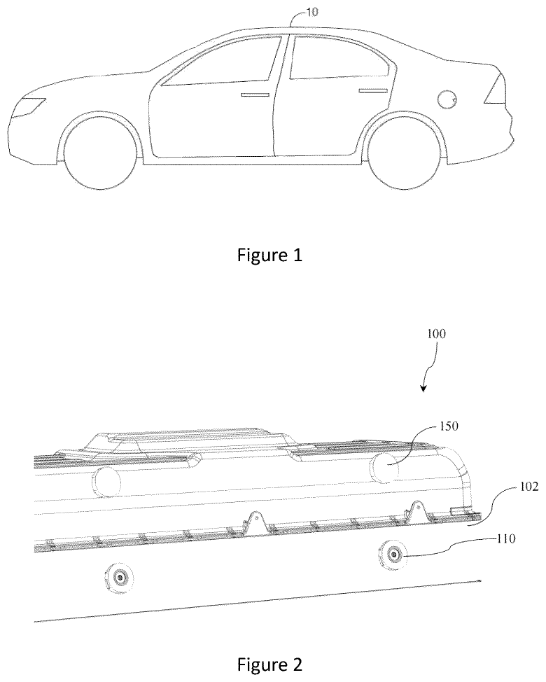

With reference to FIGS. 1 and 2 a vehicle 10 includes a vehicle battery humidity control device 110 according to one or more embodiments of the present disclosure. It should be understood that in the context of the present disclosure, the vehicle 10 implementing the present disclosure can refer to any means of transportation including a vehicle battery pack, such as but not limited to, fossil fuel vehicles, electric vehicles (such as plug-in hybrid electric vehicles (PHEVs), fully hybrid electric vehicles (FHEVs), mild hybrid electric vehicles (MHEVs) or battery electric vehicles (BEVs), and even ships, aircrafts, etc. The vehicle can include components related to mobility, such as engine, electric motor, transmission, suspension, drive shaft, and/or wheels. The vehicle 10 can be non-autonomous, semi-autonomous (for example, some conventional motion functions are controlled independently by the vehicle) or autonomous (for example, motion functions are controlled independently by the vehicle without direct input from user).

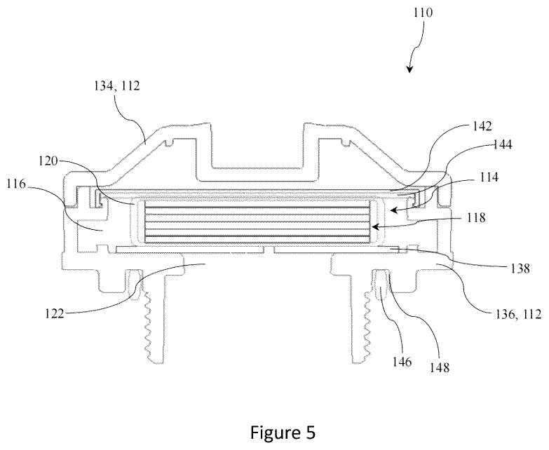

In view of the foregoing, an aspect of the present disclosure provides a vehicle battery humidity control device 110. As generally shown in FIGS. 2 to 11, the vehicle battery humidity control device 110 includes a shell 112 and a humidity control core 114. Wherein, the shell 112 of the vehicle battery humidity control device 110 is installed on a vehicle battery pack 100, as shown in FIG. 2; a receiving cavity 116 is formed inside the shell 112 and the shell 112 includes a ventilation opening 122. The receiving cavity 116 is communicated to an internal space of the vehicle battery pack 100 through the ventilation opening 122, which is more clearly shown in FIG. 5. Referring also to FIG. 5, the humidity control core 114 is arranged in the receiving cavity 116, and includes a humidity control structure 118 and a waterproof and breathable film 120. The waterproof and breathable film 120 is arranged between the humidity control structure 118 and the ventilation opening 122.

In the context of the present disclosure, the shell 112 of the vehicle battery humidity control device 110 can be installed in any suitable position on a housing 102 of the vehicle battery pack 100, as long as the receiving cavity 116 of the shell 112 is ensured to circulate with the overall gas inside the vehicle battery pack 100 through the ventilation opening 122 to not hinder its own humidity control function, such as but not limited to, installed in the front of the vehicle battery pack 100 at a position corresponding to a vent valve 150, as shown in FIG. 2. In addition, the material of the waterproof and breathable film 120 can be selected from any existing or potential developed breathable and liquid blocking film material, such as but not limited to, EPTFE (polytetrafluoroethylene) film, TPU (thermoplastic polyurethanc) film, PU (polyurethane) film, etc. In an embodiment of the present disclosure, the shell 112 is installed on the vehicle battery pack 100, ensuring more convenient maintenance of the vehicle battery humidity control device 110 when necessary and easy replacement at any time. In addition, providing the waterproof and breathable film 120 between the humidity control structure 118 and the ventilation opening 122 (i.e., inside the vehicle battery pack 100) can ensure that liquids that may condense inside the vehicle battery humidity control device 110 do not enter the internal space of the vehicle battery pack 100. At the same time, the breathability of the waterproof and breathable film 120 allows for the humidity control structure 118 to release moisture back into the internal space of the vehicle battery pack 100 and release it into the external environment of the vehicle through the vent valve 150 on the vehicle battery pack 100 in the event of low humidity inside the vehicle battery pack 100, which correspondingly extends the life cycle of the vehicle battery humidity control device 110.

Referring once again to the embodiment shown in FIG. 5, the waterproof and breathable film 120 can completely enclose and surround the humidity control structure 118, that is, the waterproof and breathable film 120 is integrally wrapped around the humidity control structure 118 to isolate it from the receiving cavity 116. This enables the humidity control core 114 to be manufactured as a single unit, providing better sealing effect and more convenient overall replacement for the humidity control structure 118 inside.

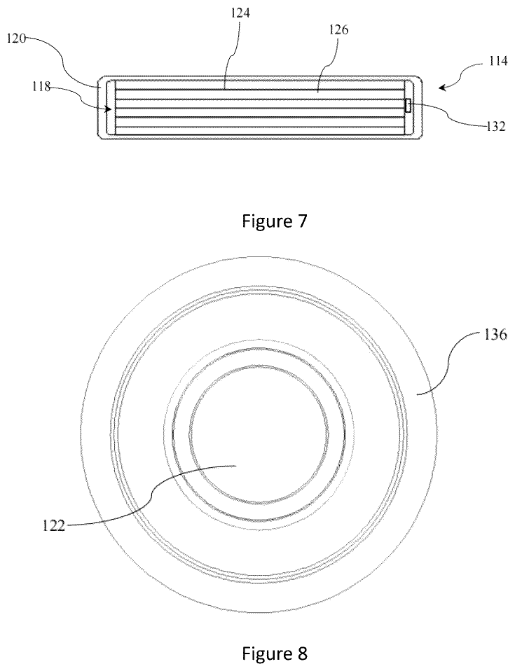

Referring to FIG. 7, according to some embodiments of the present disclosure, the humidity control structure 118 can include a first material layer 124 and a second material layer 126, wherein the second material layer 126 is at least partially embedded in the first material layer 124. As can be further seen in the figure, there can be several first material layer 124 and second material layer 126 and they are staggered, that is, the second material layer 126 can be placed between every two first material layer 124, and of course other layouts can also be adopted. Overall, the first material layer 124 serves as an intermediate support structure or skeleton of the humidity control structure 118, while the second material layer 126 serves as a main moisture absorption part, which can prevent the possibility of excessive aggregation of the hygroscopic materials (such as hygroscopic agents) that may cause agglomeration after water absorption, ensuring that the humidity control structure 118 can fully release the moisture contained in it and release it to the external environment through the vent valve 150 in the vehicle battery pack 100 and on the vehicle battery pack 100 when the humidity inside the vehicle battery pack 100 is low, to extend the life cycle of the vehicle battery humidity control device 110. Of course, those skilled in the art can understand that while the first material layer 124 serves as an intermediate support structure, it does not rule out that the first material layer 124 can also play a partial hygroscopic role, such as by manufacturing the first material layer 124 through hygroscopic fast drying fiber materials. In addition, the number and layout of the first material layer 124 and the second material layer 126 may not be limited to those shown in the figure, but may be adjusted according to the actual humidity control needs of the vehicle battery pack 100, such as, more or fewer first material layer 124 and second material layer 126 can be arranged according to the volume of the vehicle battery pack 100.

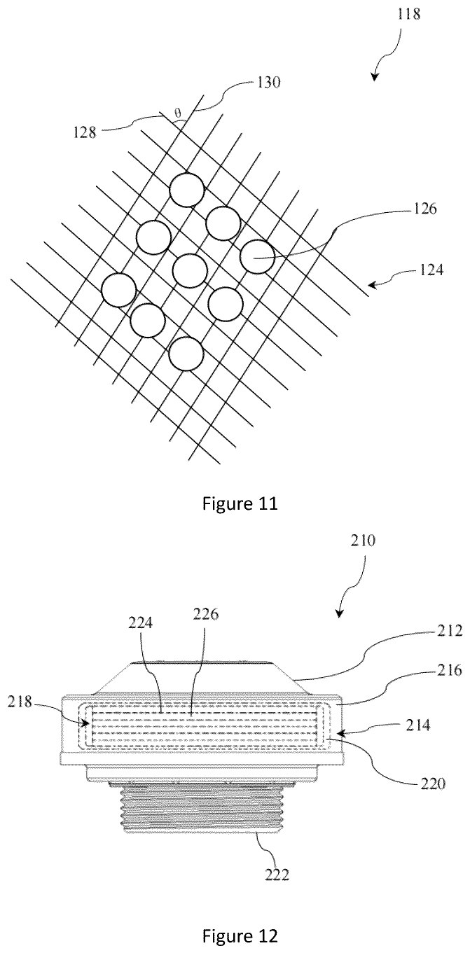

As shown in FIG. 11, according to some embodiments of the present disclosure, the first material layer 124 may include a mesh material layer, such as but not limited to a woven mesh material or a mesh material formed into one-piece. In addition, it can be understood that the expression of “mesh” should not only include two-dimensional network structures, but also include three-dimensional network structures. This feature can further ensure the dispersion of the hygroscopic material (such as hygroscopic agent) in the second material layer 126, prevent agglomeration after water absorption, and enable the humidity control structure 118 to fully release the moisture contained in it if necessary. Furthermore, in some embodiments of the present disclosure, the mesh material layer in the first material layer 124 can have a pore size smaller than the particle size of the material (such as a hygroscopic agent) contained in the second material layer 126, as shown in FIG. 11. This ensures that the first material layer 124 can better maintain and fix the material contained in the second material layer 126, preventing it from passing through the mesh material layer of the first material layer 124 and aggregating, ensuring that the humidity control structure 118 can fully release the moisture contained in it when necessary.

Specifically, in the embodiment shown in FIG. 11, the first material layer 124 may include fiber cloth (such as but not limited to, natural fiber cloth such as cotton and linen, synthetic fiber cloth such as nylon, polyester, acrylic, etc.), and the second material layer 126 may include microporous hygroscopic materials. The microporous hygroscopic materials can be porous materials with a pore size less than 2 nm, including various organic or inorganic microporous particles, such as but not limited to, conjugated microporous polymers (CMPs), covalent organic framework materials (COFs), metal organic framework materials (MOFs), and so on. FIG. 10 shows a schematic diagram of the principle of moisture absorption of the microporous materials. When the humidity X in the environment is greater than a control value of the microporous materials, water vapor enters and stays in the microporous materials; and when the humidity X in the environment is less than the control value of the microporous materials, the water vapor is released into the environment due to the pressure inside the micropores. As shown in FIG. 11, according to some further embodiments of the present disclosure, the fiber cloth of the first material layer 124 has warp lines 128 and weft lines 130 at an angle θ between 20 and 80 degrees. This provides better fixation and retention for the materials contained in the second material layer 126, such as microporous hygroscopic materials, preventing their free movement and aggregation, and allowing them to release water vapor more fully when needed.

Returning to FIG. 7, in some embodiments of the present disclosure, the vehicle battery humidity control device 110 also includes a humidity sensor 132 for detecting humidity inside the humidity control structure 118. The humidity sensor 132 is configured to emit an alarm signal in response to detecting that the humidity inside the humidity control structure 118 exceeds a threshold for a first preset time (such as but not limited to, 24 or 48 hours, etc.), and/or emit an alarm signal in response to detecting that a humidity change value inside the humidity control structure 118 is less than a threshold for a second preset time (such as but not limited to 48 or 72 hours, etc.). For example, the alarm signal can be sent to an in-car infotainment system (not shown) and presented to a vehicle user. By detecting and alerting users that the humidity is above the threshold or the humidity change value is below the threshold for a prolonged period of time (the specific time can be set by the supplier or driver), the users can be prompted to replace the vehicle battery humidity control device 110 or its internal maintainable components (the humidity control core 114) when needed, ensuring its effectiveness in operation.

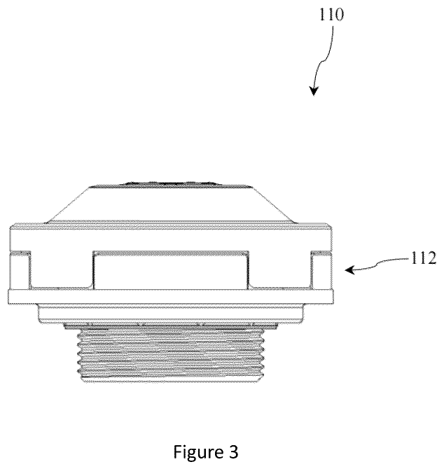

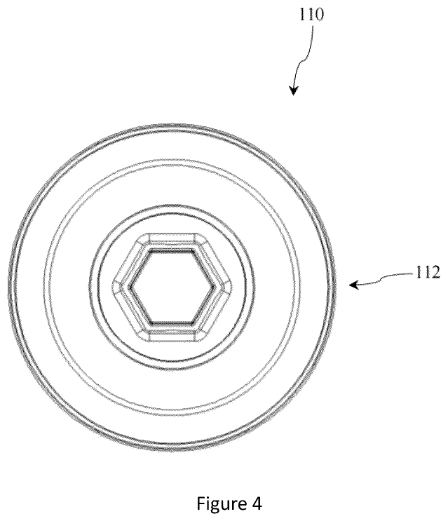

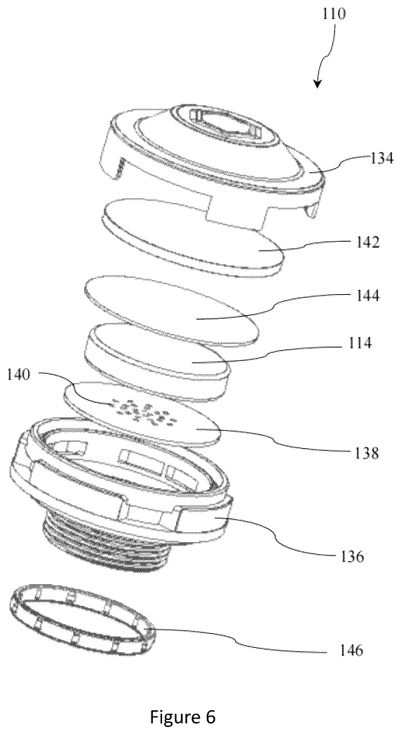

Returning to side and top views in FIGS. 3 and 4, cross-sectional view in FIG. 5 and exploded view in FIG. 6, according to some embodiments of the present disclosure, the shell 112 may include a lower shell 134 and an upper shell 136. In an assembled state, the lower shell 134 is installed on the vehicle battery pack 100, the upper shell 136 is connected to the lower shell 134, and the two are enclosed to form the receiving cavity 116. The design of the upper and lower shells is conducive to simpler maintenance and replacement after reaching the service cycle of the humidity control core 114, for example. As can be seen in FIGS. 5 and 6, the lower shell 134 can include a sealing ring 146 and an annular groove 148, and the annular groove 148 is located on the side of the lower shell 134 facing the vehicle battery pack 100 to facilitate the placement of the sealing ring 146 within the annular groove 148. The sealing ring 146 provides better internal sealing, while the annular groove 148 facilitates the fixation of the sealing ring 146

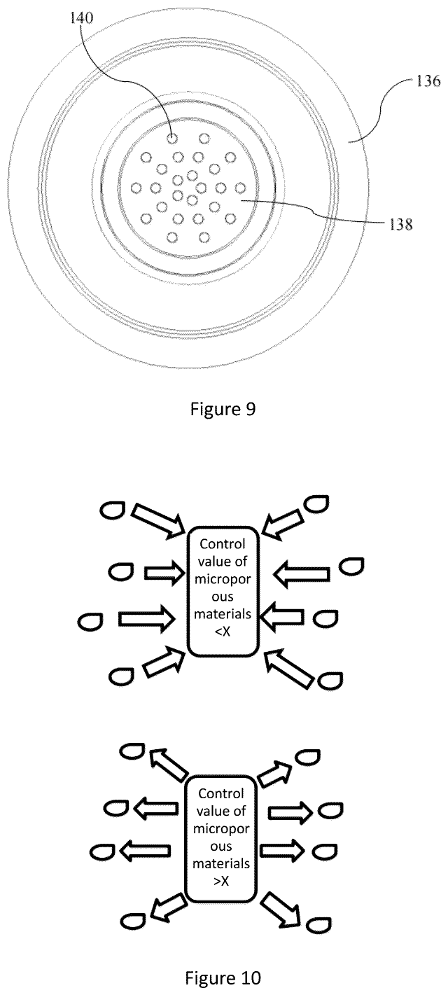

Referring to FIGS. 8 and 9 below and continuing with FIGS. 5 and 6, according to some embodiments of the present disclosure, the shell 112 may also include a partition support plate 138. The partition support plate 138 covers the ventilation opening 122 on the lower shell 134, and includes several air holes 140 on it (the number and diameter of the holes can be adjusted according to actual humidity control needs and material characteristics). The humidity control core 114 is placed on the partition support plate 138 and covers the several air holes 140, which can assist in providing better support for the humidity control core 114 and ensure gas exchange between the humidity control core 114 and the internal space of the vehicle battery pack 100. Furthermore, as shown in FIGS. 5 and 6, the shell 112 can also include a compression cover 142, which is clamped to the lower shell 134 through a buckle. The compression cover 142 cooperates with the partition support plate 138 to clamp the humidity control core 114 between the two, in order to better fix the relative positions of the first material layer 124 and the second material layer 126, providing better fixation and retention force for granular material inside the second material layer 126. This can prevent the free movement and aggregation of materials (such as the microporous hygroscopic materials) contained in the second material layer 126, ensuring that a path for free gas flow can be maintained even in the farthest part from the vehicle battery pack 100, allowing it to release water vapor more fully when needed. In several embodiments of the present disclosure, an elastic pad 144 can be provided on the side of the compression cover 142 towards the humidity control core 114 to provide elastic retention force to the humidity control core 114, while also ensuring the internal sealing of the the entire vehicle battery humidity control device 110.

In the content disclosed above and below, the structural components of the vehicle battery humidity control device 110, such as the upper shell 136, lower shell 134, partition support plate 138, and compression cover 142, can use any material that meets the corresponding mechanical performance requirements, for example, metals, such as aluminum, iron, copper, zinc, and their alloys; polymers, such as polyethylene (PE), polypropylene (PP), polyvinyl chloride (PVC), polystyrene (PS), and acrylonitrile butadiene styrene copolymers (ABS), etc .; ceramics, such as oxide ceramics, carbide ceramics, nitride ceramics, etc .; composite materials, such as carbon fiber reinforced materials, glass fiber reinforced materials, etc. The sealing ring 146 and the elastic pad 144 can use any material that provides sufficient elasticity and sealing effect, such as rubber (such as styrene butadiene rubber, butadiene rubber, nitrile rubber, silicone rubber, etc.), elastomer materials (such as thermoplastic elastomer (TPE), thermoset elastomer, etc.), etc. Furthermore, the processing and manufacturing of various components of the vehicle battery humidity control device 110 mentioned above can be achieved through methods such as but not limited to casting, molding, extrusion, stamping, 3D printing, etc. In addition, the joints or connections mentioned above or below can be achieved through various alternative methods, such as clamping, welding, bonding, riveting, threaded connection, integrated molding, and so on.

In addition, according to another aspect of the present disclosure, there is also provided a vehicle battery pack 100. Referring to FIG. 2, the vehicle battery pack 100 includes the housing 102 of the vehicle battery pack 100, the shell 112 installed on the housing 102 of the vehicle battery pack 100, and the humidity control core 114. Wherein, the shell 112 forms the receiving cavity 116, which is communicated to the internal space of the housing 102 of the vehicle battery pack 100 through the ventilation opening 122 on the shell 112, and the humidity control core 114 is arranged inside the receiving cavity 116. The humidity control core 114 includes the humidity control structure 118 and the waterproof and breathable film 120 that encloses the humidity control structure 118 in a closed manner. The humidity control structure 118 includes a first material layer 124 and a second material layer 126, with the second material layer 126 at least partially embedded in the first material layer 124.

Overall, the vehicle battery pack 100 may include a vehicle battery humidity control device 110 as described in any of the above embodiments. Therefore, it should be understood that all the embodiments, features, and advantages described above for the vehicle battery humidity control device 110 according to the first aspect of the present disclosure are equally applicable to the vehicle battery pack 100 according to another aspect of the present disclosure, without conflicting with each other. That is to say, all the embodiments and their variations mentioned above can be directly applied and combined with them. For the sake of brevity in this disclosure, it will not be repeated herc.

According to yet another aspect of the present disclosure, there is also provided a humidity control device 210. Referring to FIG. 12, the humidity control device 210 comprises a shell 212 and a humidity control core 214. Wherein, the shell 212 is formed with a receiving cavity 216, which is communicated to a ventilation opening 222 on the shell 212. The humidity control core 214 is arranged in the receiving cavity 116 and includes a humidity control structure 218 and a waterproof and breathable film 220 located between the humidity control structure 218 and the ventilation opening 122. Furthermore, the humidity control structure 218 can include a first material layer 224 and a second material layer 226, with the second material layer 226 at least partially embedded in the first material layer 224. It can be understood that the humidity control device 210 according to the present disclosure can be used for any device that needs to control internal humidity, such as precision electronic devices or optical devices, and the ventilation opening 222 can lead to the internal space of the device for gas exchange. Similarly, it should be understood that all the embodiments, features, and advantages described above for the vehicle battery humidity control device 110 according to the first aspect of the present disclosure are equally applicable to the humidity control device 210 according to the yet another aspect of the present disclosure, without conflicting with each other. That is to say, all embodiments and their variations mentioned above can be directly applied and combined with them. For the sake of brevity in this disclosure, it will not be repeated here.

In summary, compared to the prior art, the present disclosure proposes a vehicle battery humidity control device, corresponding vehicle battery pack, and humidity control device. In the technical solution of the present disclosure, the overall structure of the humidity control device is more simplified, and can facilitate achieving humidity control inside the vehicle battery pack.

It should be understood that, on the premise of technical feasibility, the technical features listed above for different embodiments can be combined with each other to form other embodiments within the scope of the present disclosure.

It should be understood that, on the premise of technical feasibility, the technical features listed above for different embodiments can be combined with each other to form other embodiments within the scope of the present disclosure.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A vehicle battery humidity control device, comprising:
a shell installed on a vehicle battery pack and formed with a receiving cavity, the receiving cavity configured to communicate with an internal space of the vehicle battery pack through a ventilation opening on the shell; and
a humidity control core arranged in the receiving cavity, including:
a humidity control structure; and
a waterproof and breathable film located between the humidity control structure and the ventilation opening.

2. The vehicle battery humidity control device according to claim 1, wherein the humidity control structure comprises a first material layer and a second material layer that is at least partially embedded in the first material layer.

3. The vehicle battery humidity control device according to claim 2, wherein the first material layer comprises a mesh material layer.

4. The vehicle battery humidity control device according to claim 3, wherein the mesh material layer has a pore size smaller than a particle size of a material of the second material layer.

5. The vehicle battery humidity control device according to claim 2, wherein the first material layer comprises fiber cloth and the second material layer comprises microporous hygroscopic materials.

6. The vehicle battery humidity control device according to claim 5, wherein the fiber cloth has warp and weft lines at an angle between 20 and 80 degrees.

7. The vehicle battery humidity control device according to claim 1, wherein the waterproof and breathable film encloses the humidity control structure in a closed manner.

8. The vehicle battery humidity control device according to claim 1, further comprising a humidity sensor configured to detect humidity inside the humidity control structure, the humidity sensor is configured to emit an alarm signal in response to detecting that the humidity inside the humidity control structure exceeds a threshold for a first preset time, to emit an alarm signal in response to detecting that a humidity change value inside the humidity control structure is less than a threshold for a second preset time, or both.

9. The vehicle battery humidity control device according to claim 1, wherein the shell comprises a lower shell installed on the vehicle battery pack and an upper shell connected to the lower shell, wherein the upper shell and the lower shell provide the receiving cavity.

10. The vehicle battery humidity control device according to claim 9, wherein the shell further includes a partition support plate that includes several air holes and covers the ventilation opening on the lower shell, wherein the humidity control core is arranged on the partition support plate and covers the several air holes.

11. The vehicle battery humidity control device according to claim 10, wherein the shell further includes a compression cover clamped onto the lower shell to compress the humidity control core to the partition support plate.

12. The vehicle battery humidity control device according to claim 11, wherein the compression cover is provided with an elastic pad on a side facing the humidity control core.

13. A vehicle battery pack, comprising:
a vehicle battery pack housing;
a shell installed on the vehicle battery pack housing and formed with a receiving cavity, the receiving cavity being communicated to an internal space of the shell through a ventilation opening on the shell; and
a humidity control core arranged in the receiving cavity, the humidity control core including:
a humidity control structure comprising a first material layer and a second material layer at least partially embedded in the first material layer; and
a waterproof and breathable film enclosing the humidity control structure in a closed manner.

14. The vehicle battery pack according to claim 13, wherein the first material layer comprises a mesh material layer.

15. The vehicle battery pack according to claim 14, wherein the mesh material layer has a pore size smaller than a particle size of a material of the second material layer.

16. The vehicle battery pack according to claim 14, wherein the first material layer comprises fiber cloth, the second material layer comprises microporous hygroscopic material, and the fiber cloth has warp and weft lines at an angle between 20 and 80 degrees.

17. The vehicle battery pack according to claim 13, further comprising a humidity sensor configured to detect humidity inside the humidity control structure, and the humidity sensor is configured to emit an alarm signal in response to detecting that the humidity inside the humidity control structure exceeds a threshold for a first preset time, and/or to emit an alarm signal in response to detecting that a humidity change value inside the humidity control structure is less than a threshold for a second preset time.

18. The vehicle battery pack according to claim 13, wherein the shell comprises a lower shell installed on the vehicle battery pack housing, an upper shell connected to the lower shell, a partition support plate, and a compression cover, the upper shell and the lower shell are enclosed to form the receiving cavity, the partition support plate covers the ventilation opening on the lower shell and includes several air holes, the humidity control core is arranged on the partition support plate and covers the several air holes, and the compression cover is clamped onto the lower shell to compress the humidity control core to the partition support plate.

19. A humidity control device, comprising:
a shell formed with a receiving cavity, the receiving cavity being communicated to a ventilation opening on the shell; and
a humidity control core arranged in the receiving cavity, including:
a humidity control structure; and
a waterproof and breathable film located between the humidity control structure and the ventilation opening.

20. The humidity control device according to claim 19, wherein the humidity control structure comprises a first material layer and a second material layer at least partially embedded in the first material layer.
